(19) United States
(12) Patent Application Publication
(10) Pub. No.: US 2026/0012093 A1
(43) Pub. Date: Jan. 8, 2026

(54) Circuit Device And Switching Regulator

(71) Applicant: SEIKO EPSON CORPORATION, Tokyo (JP)

(72) Inventors: Kei ISHIMARU, Chino (JP); Yoshiyuki YAMAGUCHI, Matsumoto (JP)

(21) Appl. No.: 19/256,515

(22) Filed: Jul. 1, 2025

(30) Foreign Application Priority Data
Jul. 2, 2024 (JP) 2024-106576

(51) Int. Cl. H02M 3/157; H02M 1/00; H02M 1/08

(52) U.S. Cl. CPC H02M 3/157; H02M 1/0025; H02M 1/08

(57) ABSTRACT

A circuit device includes an error amplifier, a slope voltage generation circuit, an addition circuit, a comparator, and a switching control circuit. The error amplifier amplifies the error between a comparison voltage corresponding to an output voltage and a reference voltage and outputs an error voltage. A slope voltage generation circuit generates a slope voltage. The addition circuit adds an addition voltage corresponding to the output voltage to the slope voltage and outputs a post-addition slope voltage. The comparator compares the error voltage and the post-addition slope voltage and outputs an output signal, which is a comparison result. The switching control circuit performs switching control on a switching element based on the output signal.

The present application is based on, and claims priority from JP Application Serial Number 2024-106576, filed Jul. 2, 2024, the disclosure of which is hereby incorporated by reference herein in its entirety.

### BACKGROUND

### 1. Technical Field

The present disclosure relates to a circuit device, a switching regulator, and the like.

### 2. Related Art

In the related art, a switching regulator configuring a DCDC converter has been known. JP-A-2000-032745 discloses a method in which an error amplifier (a feedback amplifier) that compares an output voltage with a reference voltage detects an error amount and a PWM comparator compares the error amount and a slope voltage to adjust a duty cycle of a drive signal of a power switch.

JP-A-2000-032745 is an example of the related art.

In the method of the related art, since the error amplifier includes an integration capacitor, there is a problem in that feedback for a steep drop in the output voltage is slow and a fluctuation range of the output voltage increases. For that reason, it is desired to propose a method relating to a switching regulator applicable to a wider range of electronic equipment.

### SUMMARY

An aspect of the present disclosure relates to a circuit device used in a switching regulator that outputs an output voltage obtained by regulating a power supply voltage with an inductor and a switching element that drives the inductor, the circuit device including: an error amplifier configured to amplify an error between a comparison voltage corresponding to the output voltage and a reference voltage and output an error voltage; a slope voltage generation circuit configured to generate a slope voltage; an addition circuit configured to add an addition voltage corresponding to the output voltage to the slope voltage and output a post-addition slope voltage; a comparator configured to compare the error voltage and the post-addition slope voltage and output a pulse signal, which is a comparison result; and a switching control circuit configured to perform switching control on the switching element based on the pulse signal.

Another aspect of the present disclosure relates to a switching regulator including: the circuit device explained above; the switching element; and the inductor.

### BRIEF DESCRIPTION OF THE DRAWINGS

FIG. 1 is a diagram illustrating a configuration example of a switching regulator including a circuit device.

FIG. 2 is a diagram conceptually illustrating an operation of the circuit device.

FIG. 3 is a diagram conceptually illustrating action in the present embodiment.

FIG. 4 is a diagram conceptually illustrating an effect in the present embodiment.

FIG. 5 is a diagram illustrating a first voltage divider circuit, a second voltage divider circuit, and an error amplifier more in detail.

FIG. 6 is a diagram illustrating an example of a contactless power transfer system.

FIG. 7 is a diagram illustrating an example of electronic equipment.

### DESCRIPTION OF EMBODIMENTS

Hereinafter, a preferred embodiment of the present disclosure is explained in detail. Note that the present embodiment explained below does not unduly limit the content described in the claims, and all of the components explained in the present embodiment are not always essential elements.

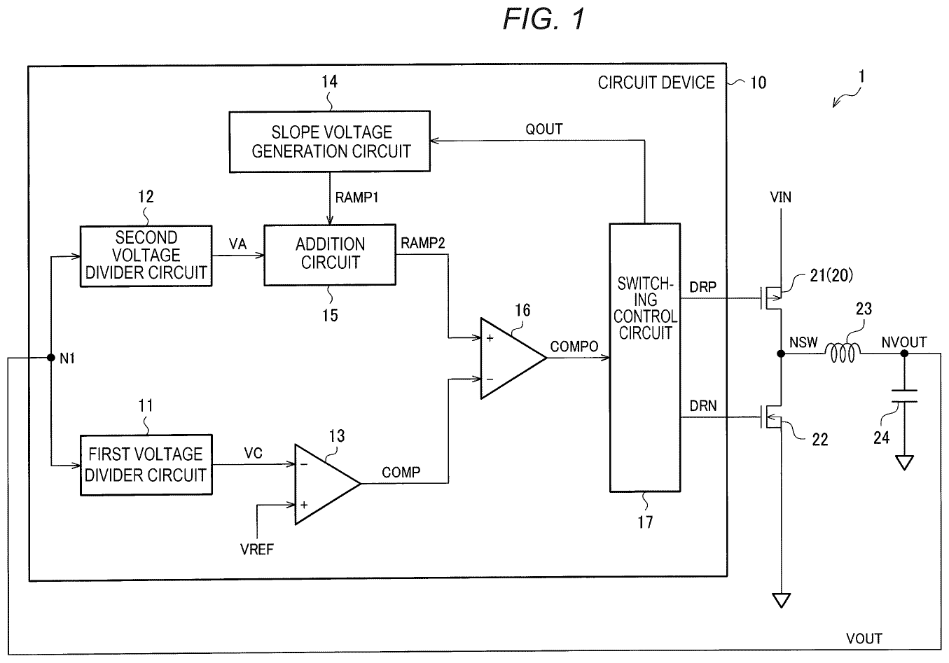

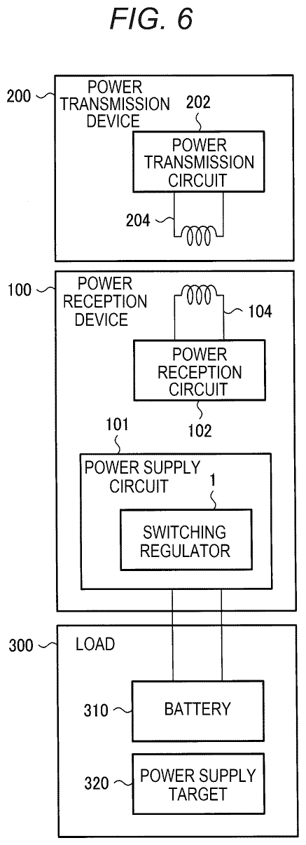

FIG. 1 is a configuration example of a switching regulator 1 including a circuit device 10. The switching regulator 1 regulates a power supply voltage VIN to an output voltage VOUT and supplies the output voltage VOUT to a load 300 (not illustrated in FIG. 1). A not-illustrated power supply circuit is provided on the outside or the inside of the circuit device 10 and a power supply voltage VIN is supplied from the power supply circuit to the circuit device 10. The load 300 is explained below with reference to FIG. 6.

As illustrated in FIG. 1, the switching regulator 1 in the present embodiment includes the circuit device 10, a switching element 20, and an inductor 23. The switching regulator 1 may further include a capacitor 24. The switching regulator 1 is also called DCDC converter. The inductor is also called coil. One end of the inductor 23 is coupled to a node NSW and the other end thereof is coupled to a node NVOUT, which is a node from which the output voltage VOUT is output. One end of the capacitor 24 is coupled to the node NVOUT and the other end thereof is coupled to the ground node.

The circuit device 10 is, for example, an integrated circuit device in which a plurality of circuit elements are integrated on a semiconductor substrate. As illustrated in FIG. 1, the circuit device 10 in the present embodiment includes an error amplifier 13, a slope voltage generation circuit 14, an addition circuit 15, a comparator 16, and a switching control circuit 17.

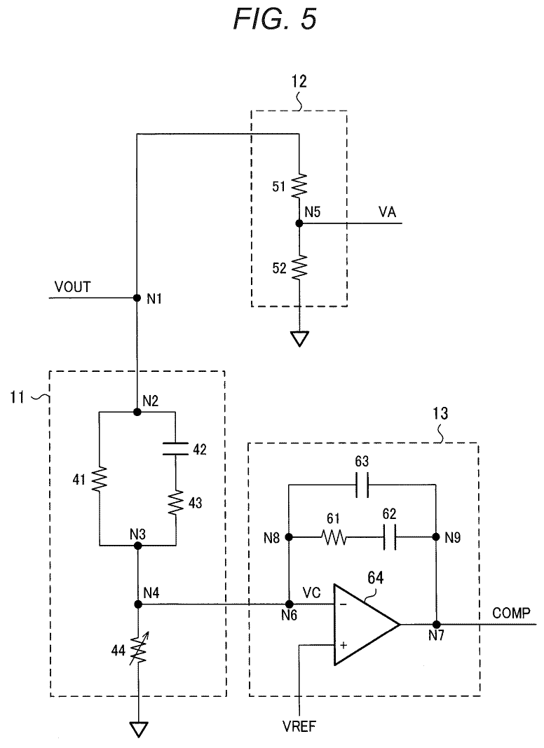

The error amplifier 13 amplifies the error between a comparison voltage VC corresponding to the output voltage VOUT and the reference voltage VREF and outputs an error voltage COMP. Details of the comparison voltage VC are explained below. The error amplifier 13 is an integration circuit that integrates the difference between the comparison voltage VC and the reference voltage VREF and includes an operational amplifier and an integration capacitor. Specific examples of the operational amplifier and the integration capacitor are explained below with reference to FIG. 5. The reference voltage VREF is input to a positive electrode input terminal of the operational amplifier, the comparison voltage VC is input to a negative electrode input terminal of the operational amplifier, and a voltage difference between an output terminal and the negative electrode input terminal of the operational amplifier is fed back by the integration capacitor.

The slope voltage generation circuit 14 receives a pulse signal QOUT explained below from the switching control circuit 17, generates a slope voltage RAMP1, which rises with elapse of time, when the received pulse signal QOUT is at a high level, and resets the slope voltage RAMP1 when the pulse signal QOUT is at a low level. More specifically, the slope voltage generation circuit 14 generates the slope voltage RAMP1 that rises from an initial voltage at a given slope. For that reason, the slope voltage is also called triangular wave. The initial voltage refers to a voltage at the time when a slope is started. A specific value of the initial voltage is determined as appropriate. The reset of the slope voltage RAMP1 means a value of the slope voltage RAMP1 becoming a value of the initial voltage. Hereinafter, the “voltage value” is sometimes simply described as “voltage” and the “current value” is sometimes simply described as “current”.

The addition circuit 15 is a voltage addition circuit that adds an addition voltage VA to the slope voltage RAMP1 and outputs a post-addition slope voltage RAMP2. An initial voltage of the post-addition slope voltage RAMP2 is the sum of an initial voltage of the slope voltage RAMP1 and the addition voltage VA and, when the slope voltage RAMP1 rises at the given slope, the post-addition slope voltage RAMP2 also rises at the given slope. The addition voltage VA is a voltage corresponding to the output voltage VOUT and, as explained in detail below, for example, the addition voltage VA rises as the output voltage VOUT rises and the addition voltage VA drops as the output voltage VOUT drops. Although not illustrated in detail, the addition circuit 15 includes, for example, a plurality of common source circuits and a current mirror circuit. For example, a path of a first current based on a first common source circuit and the addition voltage VA and a path of a second current based on a second common source circuit and the slope voltage RAMP1 are connected in parallel via a predetermined node, whereby an electric current at a predetermined node is the sum of the first current and the second current. Then, a predetermined node is coupled to the current mirror circuit and a path of a mirrored current is coupled to a third common source circuit, whereby a post-addition slope voltage RAMP2, which is a voltage obtained by adding up the addition voltage VA and the slope voltage RAMP1, is output from the third common source circuit. The above is an example in which the slope voltage RAMP1 and the addition voltage VA are added up by a current addition method. However, not only this, but, for example, an example in which the slope voltage RAMP1 and the addition voltage VA are added up by a voltage addition method by an operational amplifier, a resistor, and the like, may be adopted. As explained above, the addition circuit 15 in the present embodiment adds the addition voltage VA corresponding to the output voltage VOUT to the slope voltage RAMP1 and outputs the post-addition slope voltage RAMP2.

The comparator 16 compares the error voltage COMP and the post-addition slope voltage RAMP2 and outputs a result of the comparison as the output signal COMPO. More specifically, for example, in FIG. 1, the error voltage COMP is input to a negative electrode input terminal of the comparator 16 and the post-addition slope voltage RAMP2 is input to a positive electrode input terminal thereof. As explained above, the comparator 16 in the present embodiment compares the error voltage COMP and the post-addition slope voltage RAMP2 and outputs the output signal COMPO, which is a comparison result.

When receiving the output signal COMPO, the switching control circuit 17 outputs a drive signal DRP to the switching element 20. The switching control circuit 17 outputs a pulse signal QOUT to the slope voltage generation circuit 14 explained above.

The switching control circuit 17 includes, for example, a controller (not illustrated) and a pre-driver (not illustrated). The controller includes, for example, an RS latch circuit (not illustrated) and an off-timer (not illustrated). For example, the length of an off-time in which the switching element 20 is off is set in the off-timer. The RS latch circuit receives input of a set signal SET from the off-timer as a set signal, receives input of the output signal COMPO from the comparator 16 as a reset signal, and outputs the pulse signal QOUT based on the set signal and the reset signal. Although not illustrated, the pulse signal QOUT is transmitted to each of the pre-driver, the off-timer, and the slope voltage generation circuit 14. When the pulse signal QOUT to be input is at the high level, the pre-driver controls the drive signal DRP such that the switching element 20 is turned on. In other words, when the pulse signal QOUT to be input is at the low level, the pre-driver controls the drive signal DRP such that the switching element 20 is turned off.

The switching element 20 only has to be an element that can be switched by control of the switching control circuit 17. FIG. 1 illustrates a switching element 21 as one specific example. The switching element 21 is a P-type MOS transistor. A source of the switching element 21 is coupled to a node of the power supply voltage VIN and a drain thereof is coupled to the node NSW. The drive signal DRP from the switching control circuit 17 is input to a gate of the switching element 21. When the switching element 21 is on, the inductor 23 is driven by the power supply voltage VIN. Although details of a specific operation are omitted, the switching element 20 is not limited to the switching element 21 serving as a P-type MOS transistor and can also be implemented by, for example, an N-type MOS transistor or a bipolar transistor.

When the switching element 20 is the switching element 21 serving as the P-type MOS transistor, the pre-driver explained above turns on the switching element 21 by setting the drive signal DRP to the low level when the pulse signal QOUT to be input is at the high level. Similarly, the pre-driver turns off the switching element 21 by setting the drive signal DRP to the high level when the pulse signal QOUT to be input is at the low level.

The switching regulator 1 in the present embodiment may be either a synchronous type or an asynchronous type. However, FIG. 1 illustrates a synchronous type using the switching element 21 explained above and a switching element 22. The switching element 22 is an N-type MOS transistor. A source of the switching element 22 is coupled to the ground node and a drain thereof is coupled to the node NSW. A drive signal DRN from the switching control circuit 17 is input to a gate of the switching element 22. When the switching regulator 1 is the asynchronous type, the switching element 22 may be a diode. In this case, an anode of the switching element 22 may be coupled to the ground node and a cathode thereof may be coupled to the node NSW. In the following explanation, the switching element 20 is sometimes specifically replaced with the switching element 21. When the switching regulator 1 is the synchronous type, the pre-driver explained above may control the drive signal DRP and the drive signal DRN based on a logic of the pulse signal QOUT to be signals exclusively indicating ON and OFF. Specifically, for example, when the pulse signal QOUT to be input is at the high level, the pre-driver controls the drive signal DRP to be a signal indicating ON and controls the drive signal DRN to be a signal indicating OFF. When the pulse signal QOUT to be input is at the low level, the pre-driver controls the drive signal DRP to be a signal indicating OFF and controls the drive signal DRN to be a signal indicating ON.

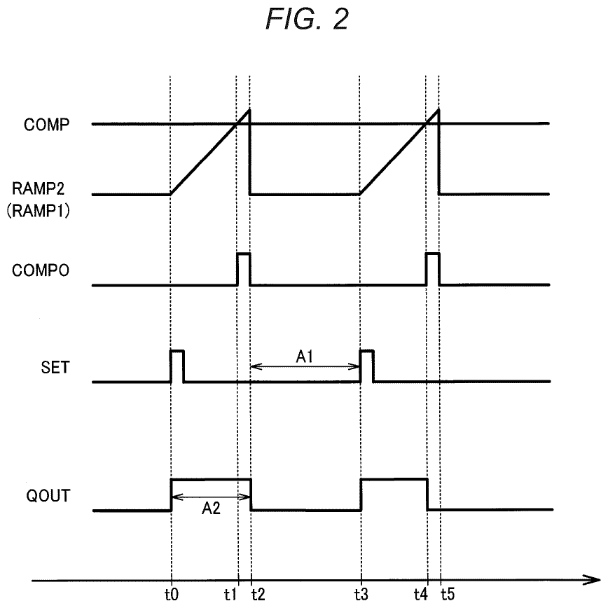

FIG. 2 is a waveform example illustrating an example of an operation of the circuit device 10 in a steady state. Here, the steady state refers to an ideal state in which an electric current flowing to the load 300 (hereinafter referred to as “load current”) and the output voltage VOUT fall within a certain range. In the steady state, the error amplifier 13 outputs the error voltage COMP, which is a constant voltage. For example, at timing t0 in FIG. 2, since the set signal SET of the off-timer provided in the switching control circuit 17 changes to the high level, the RS latch circuit changes the pulse signal QOUT to the high level. Accordingly, the slope voltage generation circuit 14 generates the slope voltage RAMP1 and the slope voltage RAMP1 rises. Accordingly, the post-addition slope voltage RAMP2 also starts to rise. Since the pulse signal QOUT changes to the high level, the pre-driver changes the drive signal DRP to the low level to turn on the switching element 21. Accordingly, energy is stored in the inductor 23.

At timing t1, which is timing later than the timing t0, when the comparator 16 determines that the post-addition slope voltage RAMP2 has exceeded the error voltage COMP, the comparator 16 outputs the output signal COMPO at the high level to the switching control circuit 17.

The RS latch circuit provided in the switching control circuit 17 changes the pulse signal QOUT to the low level based on the input output signal COMPO at the high level. A delay period may be provided between the timing when the output signal COMPO changes to the high level and timing when the pulse signal QOUT changes to the low level. In the present embodiment, the pulse signal QOUT is set to be at the low level at timing t2, which is timing later than the timing t1. Accordingly, the pulse signal QOUT changes to the high level only in a period indicated by A2. Then, at the timing t2, since the pulse signal QOUT changes to the low level, the off-timer is started, the slope voltage RAMP1 is reset, and the output signal COMPO changes to the low level. Since the pulse signal QOUT changes to the low level, the pre-driver changes the drive signal DRP to the high level to turn off the switching element 21. As explained above, the switching control circuit 17 in the present embodiment changes the switching element 20 from ON to OFF based on the comparator 16 determining that the post-addition slope voltage RAMP2 has exceeded the error voltage COMP.

Then, since the off-timer operates until timing t3, which is timing later than the timing t2, the set signal SET is maintained at the low level. Accordingly, the pulse signal QOUT is also maintained at the low level, the slope voltage generation circuit 14 outputs the slope voltage RAMP1 to maintain the initial voltage, and the slope voltage RAMP1 does not rise at the given slope. For that reason, from the timing t2 to the timing t3, the post-addition slope voltage RAMP2 does not rise at the given slope either. For that reason, since the pulse signal QOUT is also maintained at the low level from the timing t2 to the timing t3, the drive signal DRP is maintained at the high level. Therefore, the switching element 21 is maintained in an OFF state. As explained above, in the circuit device 10 in the present embodiment, the switching control circuit 17 turns off the switching element 20 and the slope voltage generation circuit 14 maintains the slope voltage RAMP1 at the initial voltage in a given period (a period from the timing t2 to the timing t3) after the switching element 20 changes from ON to OFF.

Then, at the timing t3, since the set signal SET of the off-timer changes to the high level, the RS latch circuit changes the pulse signal QOUT to the high level. Accordingly, the slope voltage generation circuit 14 generates the slope voltage RAMP1 and the slope voltage RAMP1 rises. The timing t3 is a timing obtained by adding a period set by the off-timer to the timing t2. In other words, a period indicated by A1 in FIG. 2 is the period set by the off-timer. Accordingly, operations at the timing t3, timing t4, and timing t5 illustrated in FIG. 2 correspond to the operations at the timing t0, the timing t1, and the timing t2 explained above, and the same operations are repeatedly performed. For that reason, for example, at the timing t3, since the slope voltage RAMP1 is raised at the given slope, the post-addition slope voltage RAMP2 also rises at the given slope. Similarly, for example, the comparator 16 changes the output signal COMPO to the high level at the timing t4, the pulse signal QOUT changes to the high level from the timing t4 to the timing t5, and the comparator 16 changes the output signal COMPO to the low level at the timing t5. As explained above, in the circuit device 10 in the present embodiment, after the given period has elapsed (after the timing t3), the switching control circuit 17 changes the switching element 20 from OFF to ON and the slope voltage generation circuit 14 raises the slope voltage RAMP1 at the given slope.

The output voltage VOUT is determined based on the energy periodically stored in the inductor 23. Although FIG. 2 illustrates an operation in the steady state, for example, when the output voltage VOUT fluctuates, the error voltage COMP fluctuates, whereby the width of the pulse signal QOUT fluctuates and the time in which the switching element 20 is on also fluctuates. Accordingly, feedback control is performed such that the output voltage VOUT is kept constant.

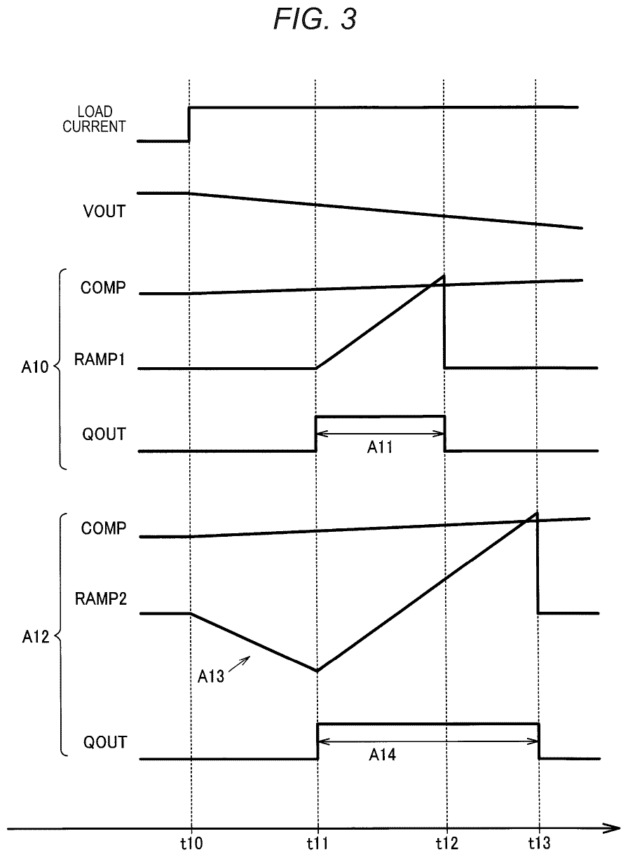

A configuration in which the switching element 20 is controlled by comparing the slope voltage RAMP1 and the error voltage COMP explained above and the output voltage VOUT is feedback-controlled has been proposed in the related art. However, since the circuit device 10 in the present embodiment further includes the addition circuit 15, unique action explained with reference to FIG. 3 occurs. Note that, in FIG. 3, explanation is omitted as appropriate concerning contents overlapping the contents explained with reference to FIG. 2.

For example, it is assumed that, at timing t10 in FIG. 3, when the magnitude of the load 300 increases, a load current increases and the output voltage VOUT starts to drop. In this case, the error voltage COMP starts to rise. A10 in FIG. 3 is a virtual waveform example in which the slope voltage RAMP1 from the slope voltage generation circuit 14 is input to the comparator 16 without passing through the addition circuit 15 in the present embodiment. On the other hand, A12 in FIG. 3 is a waveform example in which the post-addition slope voltage RAMP2 is input to the comparator 16 passing through the addition circuit 15 in the present embodiment. In order to facilitate understanding of the method in the present embodiment, it is assumed that the difference between a voltage of the error voltage COMP before the timing t10 and the initial voltage of the slope voltage RAMP1 in the waveform example of A10 and the difference between a voltage of the error voltage COMP before the timing t10 and the initial voltage of the post-addition slope voltage RAMP2 in the waveform example of A12 are equal.

Then, at timing t11, since the set signal SET not illustrated in FIG. 3 changes to the high level, the pulse signal QOUT changes to the high level. In the case of the waveform example indicated by A10, at timing t12, which is a timing later than the timing t11, the comparator 16 determines that the slope voltage RAMP1 is higher than the error voltage COMP and changes the output signal COMPO not illustrated in FIG. 3 to the high level. Accordingly, the RS latch circuit changes the pulse signal QOUT to the low level. Accordingly, the pulse signal QOUT is at the high level only in a period indicated by A11. The period indicated by A11 in FIG. 3 is longer than the period indicated by A2 in FIG. 2. This is because the error voltage COMP rises in FIG. 3 unlike in FIG. 2. Accordingly, since the switching element 20 is on for a longer period, larger energy is stored in the inductor 23. Accordingly, the dropped output voltage VOUT is fed back in a direction in which the output voltage VOUT is about to rise.

On the other hand, in a waveform example illustrated in A12, since the addition voltage VA is a voltage corresponding to the output voltage VOUT, as indicated by A13, the initial voltage of the post-addition slope voltage RAMP2 starts to drop from the timing t10 in response to the drop in the output voltage VOUT. Then, at the timing t11, the post-addition slope voltage RAMP2 starts to rise in response to the rise in the slope voltage RAMP1.

At timing t13, the comparator 16 determines that the post-addition slope voltage RAMP2 is larger than the error voltage COMP and changes the output signal COMPO not illustrated in FIG. 3 to the high level. Accordingly, the RS latch circuit changes the pulse signal QOUT to the low level. Accordingly, the pulse signal QOUT changes to the high level only in a period indicated by A14. As explained above, since the initial voltage of the post-addition slope voltage RAMP2 temporarily drops and rising speed of the slope voltage RAMP1 and rising speed of the post-addition slope voltage RAMP2 are equal, the timing t13 is timing later than the timing t12. Therefore, the period indicated by A14 is longer than the period indicated by A11.

As explained above, the application of the method in the present embodiment results in the action that a period in which the switching element 20 is on when the load current drops becomes longer than a period in which the switching element 20 is on when the addition circuit 15 is not provided. In the steady state explained above with reference to FIG. 2, there is no difference in the period in which the pulse signal QOUT is at the high level between the case indicated by A10 and the case indicated by A12.

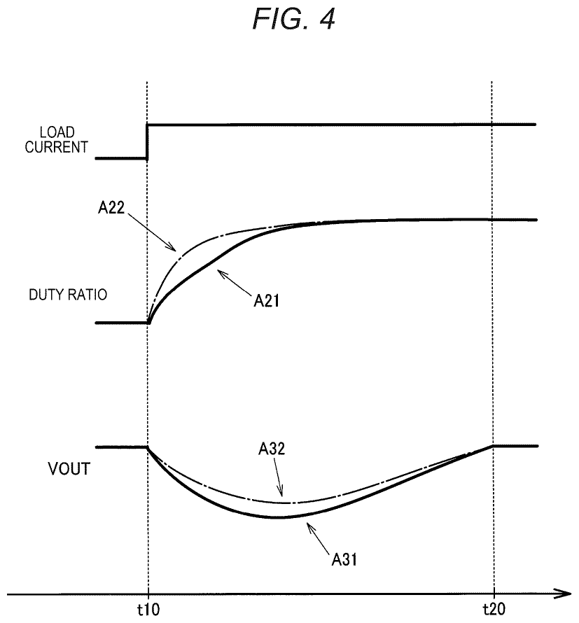

For this reason, the method in the present embodiment achieves an effect conceptually indicated by a waveform example illustrated in FIG. 4. In FIG. 4, it is assumed that, after the load current increases at the timing t10 and the output voltage VOUT drops, the output voltage VOUT dropped at timing t20 is fed back to the value at the timing t10. A21 in FIG. 4 indicates a virtual DUTY ratio of the pulse signal QOUT in the case in which it is assumed that the addition circuit 15 is not provided as explained above with reference to A10 in FIG. 3. A22 in FIG. 4 indicates a DUTY ratio of the pulse signal QOUT in the case in which the addition circuit 15 is provided as explained above with reference to A12 in FIG. 4. The DUTY ratio of the pulse signal QOUT is a ratio of a period in which the pulse signal QOUT is at the high level to the entire period in which the pulse signal QOUT is output. Comparing a waveform of A21 and a waveform of A22 in FIG. 4, it is seen that the DUTY ratio of the pulse signal QOUT increases at earlier timing in the waveform of A22. As explained above with reference to FIG. 3, this is because a period in which the pulse signal QOUT is at the high level in the case in which the addition circuit 15 is provided is longer than a period in which the pulse signal QOUT is at the high level in the case in which the addition circuit 15 is not provided.

A31 in FIG. 4 indicates a virtual waveform example conceptually indicating a behavior of the output voltage VOUT in the case in which it is assumed that the addition circuit 15 is not provided as explained above with reference to A10 in FIG. 3. A32 in FIG. 4 indicates a waveform example conceptually indicating a behavior of the output voltage VOUT in the case in which the addition circuit 15 is provided as explained above with reference to A12 in FIG. 3. When the waveform example of A31 and the waveform example of A32 are compared, since the addition circuit 15 is provided, a drop in the output voltage VOUT is suppressed to be small when the load current increases.

As explained above, the present embodiment relates to the circuit device 10 used in the switching regulator 1 that outputs the output voltage VOUT obtained by regulating the power supply voltage VIN with the inductor 23 and the switching element 20 that drives the inductor 23. The circuit device 10 includes the error amplifier 13, the slope voltage generation circuit 14, the addition circuit 15, the comparator 16, and the switching control circuit 17. The error amplifier 13 amplifies the error between a comparison voltage VC corresponding to the output voltage VOUT and the reference voltage VREF and outputs an error voltage COMP. The slope voltage generation circuit 14 generates the slope voltage RAMP1. The addition circuit 15 adds the addition voltage VA corresponding to the output voltage VOUT to the slope voltage RAMP1 and outputs the post-addition slope voltage RAMP2. The comparator 16 compares the error voltage COMP with the post-addition slope voltage RAMP2 and outputs the output signal COMPO, which is the comparison result. The switching control circuit 17 performs the switching control on the switching element 20 based on the output signal COMPO.

As explained above, since the circuit device 10 in the present embodiment includes the error amplifier 13, the slope voltage generation circuit 14, the comparator 16, and the switching control circuit 17, the circuit device 10 can be used for the switching control of the switching regulator 1. Since the addition circuit 15 is provided, when the load current increases, it is possible to extend the period in which the switching element 20 is on. Accordingly, when the load current increases, the drop in the output voltage VOUT can be reduced.

For example, a method of, when the load current increases, extending the period in which the switching element 20 is on by increasing the rising speed of the error voltage COMP is conceivable. However, an amount of an electric current flowing to the circuit device 10 increases and power consumption increases. In this regard, by applying the method in the present embodiment, it is possible to construct the circuit device 10 that reduces a fluctuation width of the output voltage VOUT while suppressing an increase in power consumption. Accordingly, the circuit device 10 in the present embodiment can be applied to more types of electronic equipment.

The method in the present embodiment may be implemented as the switching regulator 1. That is, the switching regulator 1 in the present embodiment includes the circuit device 10, the switching element 20, and the inductor 23. This makes it possible to obtain the same effects as the effects explained above.

The addition voltage VA may be lower as the output voltage VOUT is lower. This makes it possible to, when the output voltage VOUT drops, drop the initial voltage of the post-addition slope voltage RAMP2. Accordingly, it is possible to construct the circuit device 10 that, when the output voltage VOUT drops, extends the period in which the switching element 20 is on.

The slope voltage generation circuit 14 may generate the slope voltage RAMP1 that rises from the initial voltage at the given slope. The addition circuit 15 may add the addition voltage VA to the slope voltage RAMP1 and output the post-addition slope voltage RAMP2. The switching control circuit 17 may change the switching element 20 from ON to OFF based on the comparator 16 determining that the post-addition slope voltage RAMP2 has exceeded the error voltage COMP. This makes it possible to construct a circuit that, by linearly changing the post-addition slope voltage RAMP2, controls the period during which the switching element 20 is on.

In a given period (a period from the timing t2 to the timing t3 in FIG. 2) after the switching element 20 changes from ON to OFF, the switching control circuit 17 may turn off the switching element 20 and the slope voltage generation circuit 14 may maintain the slope voltage RAMP1 at the initial voltage. After the given period has elapsed, the switching control circuit 17 may change the switching element 20 from OFF to ON and the slope voltage generation circuit 14 may raise the slope voltage at the given slope. This makes it possible to construct a circuit that, by linearly changing the post-addition slope voltage RAMP2, controls both of a period in which the switching element 20 is on and a period in which the switching element 20 is off.

The comparison voltage VC and the addition voltage VA are explained more in detail. For example, as illustrated in FIG. 1, an input node of a first voltage divider circuit 11 is coupled to the node N1 and an input node of a second voltage divider circuit 12 is coupled to the node N1. The node N1 is coupled to the node NVOUT. The comparison voltage VC is output from the first voltage divider circuit 11 and the addition voltage VA is output from the second voltage divider circuit 12. That is, the comparison voltage VC is a voltage generated by dividing the output voltage VOUT with the first voltage divider circuit 11 and the addition voltage VA is a voltage generated by dividing the output voltage VOUT with the second voltage divider circuit 12. An output node from which the comparison voltage VC is output is coupled to an input node on a negative electrode side of the error amplifier 13 and an output node from which the addition voltage VA is output is coupled to an input node of the addition circuit 15.

FIG. 5 is a diagram illustrating the first voltage divider circuit 11 and the second voltage divider circuit 12 more in detail. For convenience of explanation, FIG. 5 includes a diagram illustrating the error amplifier 13 more in detail. The first voltage divider circuit 11 includes a resistor 41, a capacitor 42, a resistor 43, and a resistor 44. One end of the resistor 41 is coupled to a node N2, which is the input node of the first voltage divider circuit 11, and the other end thereof is coupled to a node N3. One end of the capacitor 42 is coupled to the node N2 and the other end thereof is coupled to one end of the resistor 43. One end of the resistor 43 is coupled to the other end of the capacitor 42 and the other end thereof is coupled to the node N3. One end of the resistor 44 is coupled to a node N4 and the other end thereof is coupled to the ground node. The node N4 is a node between the node N3 and a node N6, which is an input node on the negative electrode side of the error amplifier 13. A voltage division ratio of the first voltage divider circuit 11 is determined by the resistance values of the resistors 41, 43, and 44.

The error amplifier 13 includes a resistor 61, a capacitor 62, a capacitor 63, and an operational amplifier 64. A negative electrode input terminal of the operational amplifier 64 is coupled to the node N6, the reference voltage VREF is input to a positive electrode input terminal of the operational amplifier 64, and an output terminal of the operational amplifier 64 is coupled to a node N7. A feedback path of the error amplifier 13 includes the resistor 61, the capacitor 62, and the capacitor 63. One end of the resistor 61 is coupled to a node N8 and the other end thereof is coupled to one end of the capacitor 62. The node N8 is a connection node to the node N6. One end of the capacitor 62 is coupled to the other end of the resistor 61 and the other end thereof is coupled to a node N9. One end of the capacitor 63 is coupled to the node N8 and the other end thereof is coupled to the node N9. The node N9 is a connection node to the node N7, which is an output node of the error amplifier 13. The capacitor 62 and the capacitor 63 are phase compensation capacitors and are integration capacitors.

By configuring the first voltage divider circuit 11 and the error amplifier 13 as explained above, a relation in which the reference voltage VREF input to an input node on a positive electrode side of the error amplifier 13 has a value obtained by multiplying the magnitude of the output voltage VOUT by the voltage division ratio of the first voltage divider circuit 11 holds. The error amplifier 13 performs feedback such that the comparison voltage VC coincides with the reference voltage VREF. In other words, the output voltage VOUT is controlled by fixing the reference voltage VREF and changing the voltage division ratio of the first voltage divider circuit 11. Thus, as illustrated in FIG. 5, the resistor 44 provided in the first voltage divider circuit 11 may be a variable resistor. In other words, in the circuit device 10 in the present embodiment, the voltage division ratio of the first voltage divider circuit 11 is variable. This makes it possible to make the output voltage VOUT variable. Therefore, the circuit device 10 can be used for a wider variety of uses.

The second voltage divider circuit 12 includes a resistor 51 and a resistor 52. One end of the resistor 51 is coupled to the node N1 and the other end thereof is coupled to a node N5. One end of the resistor 52 is coupled to the node N5 and the other end thereof is coupled to the ground. The node N5 is coupled to the input node of the addition circuit 15 not illustrated in FIG. 5. A voltage division ratio of the second voltage divider circuit 12 is determined by the resistance values of the resistors 51 and 52. Accordingly, the addition voltage VA is input to the addition circuit 15 through a path not via the error amplifier 13. From a different perspective, for example, when the output voltage VOUT fluctuates, it can be considered that the fluctuation in the output voltage VOUT is directly reflected as the addition voltage VA output from the second voltage divider circuit 12 and the reflected addition voltage VA is input to the addition circuit 15.

In other words, when the output voltage VOUT fluctuates, the fluctuation in the output voltage VOUT is not directly reflected as the comparison voltage VC output from the first voltage divider circuit 11. The voltage at the node N6 is controlled to be the reference voltage VREF by virtual short of the operational amplifier of the error amplifier 13. For that reason, since the voltage at the node N4 is controlled to be equal to the voltage (the reference voltage VREF) at the node N6, the voltage at the node N4 does not coincide with the voltage obtained by multiplying the output voltage VOUT by the voltage division ratio of the first voltage divider circuit 11. Thus, the circuit device 10 in the present embodiment includes the first voltage divider circuit 11 that divides the output voltage VOUT and outputs the comparison voltage VC to the error amplifier 13 and the second voltage divider circuit 12 that divides the output voltage VOUT and outputs the addition voltage VA to the addition circuit 15. This makes it possible to input, to the addition circuit 15, the addition voltage VA generated based on the second voltage divider circuit 12 on which the fluctuation in the output voltage VOUT is directly reflected. Accordingly, it is possible to more quickly perform feedback with respect to the fluctuation in the output voltage VOUT.

Although not illustrated, the circuit device 10 in the present embodiment may have a configuration example in which the second voltage divider circuit 12 is omitted from the configuration example illustrated in FIG. 1. In this case, the output voltage VOUT and the slope voltage RAMP1 are input to the addition circuit 15 and the output voltage VOUT and the slope voltage RAMP1 are added up, whereby the post-addition slope voltage RAMP2 is output.

Whether the second voltage divider circuit 12 is required may be determined as appropriate according to, for example, the specifications of the circuit device 10. Since the components provided in the circuit device 10 operates based on the power supply voltage VIN, an allowable range of a voltage of a signal input to the comparator 16 depends on the specification of the power supply voltage VIN of the circuit device 10. For that reason, if the power supply voltage VIN of the circuit device 10 is sufficiently larger than the sum of the output voltage VOUT and the slope voltage RAMP1, the second voltage divider circuit 12 only has to be omitted.

More specifically, for example, in the circuit device 10 in which the specification of the output voltage VOUT is 1 to 3V, a case in which the amplitude of the voltage of the slope voltage RAMP1 is set to 0 to 1V and the output voltage VOUT is set to 3 V to cause the circuit device 10 to operate is considered. In this case, when the circuit device 10 does not include the second voltage divider circuit 12, the post-addition slope voltage RAMP2 of 4 V at the maximum is input to the comparator 16. Whether the circuit device 10 should include the second voltage divider circuit 12 only has to be determined according to whether the voltage of the post-addition slope voltage RAMP2 obtained in this way matches the specification of the power supply voltage VIN.

As explained above, in the circuit device 10 in the present embodiment, the voltage of the addition voltage VA is the voltage obtained by dividing the output voltage VOUT or the output voltage VOUT itself. This makes it possible to construct the circuit device 10 corresponding to both the case in which the output voltage VOUT is divided to be the addition voltage VA and the case in which the output voltage VOUT itself is the addition voltage VA.

The switching regulator 1 in the present embodiment may be applied to, for example, a contactless power transmission system illustrated in FIG. 6. The contactless power transmission system can also be referred to as a noncontact power transmission system. The contactless power transmission system illustrated in FIG. 6 includes, for example, a power reception device 100, a power transmission device 200, and the load 300.

The power transmission device 200 is a device that transmits electric power to the power reception device 100 in a contactless manner and includes a power transmission circuit 202 and a primary coil 204. The power transmission circuit 202 includes a power transmission driver that drives the primary coil 204, a power supply circuit that supplies power source to the power transmission driver, and a capacitor configuring a resonance circuit in conjunction with the primary coil 204. The power transmission circuit 202 configured as explained above generates an AC voltage having a predetermined frequency at the time of power transmission and supplies the AC voltage to the primary coil 204. The primary coil 204 is electromagnetically coupled to a secondary coil 104 to form a power transmission transformer. For example, when power transmission is necessary, a magnetic flux of the primary coil 204 is set in a state of passing through the secondary coil 104. On the other hand, when the power transmission is unnecessary, the magnetic flux of the primary coil 204 is set in a state of not passing through the secondary coil 104. Although not illustrated, the power transmission device 200 further includes a power transmission side control circuit that performs various kinds of control on a power transmission side. Specifically, for example, the power transmission side control circuit includes a communication circuit, a power supply voltage control circuit, a clock generation circuit, and a driver control circuit. The communication circuit receives power transmission voltage setting information from a power reception side. The power supply voltage control circuit generates a drive voltage for driving the power transmission driver based on the power transmission voltage setting information. The clock generation circuit generates a drive clock signal that specifies a power transmission frequency. The driver control circuit controls the power transmission driver based on the drive voltage and the drive clock signal.

The power reception device 100 is a device that receives electric power in a contactless manner from the power transmission device 200 and includes a power supply circuit 101, a power reception circuit 102, and the secondary coil 104. The power reception circuit 102 converts an AC induced voltage of the secondary coil 104 into a DC rectified voltage. The power supply circuit 101 includes the switching regulator 1 in the present embodiment and supplies electric power to the load 300 based on electric power relating to the rectified voltage converted by the power reception circuit 102. Although not illustrated, the power reception device 100 further includes a power reception side control circuit that performs various kinds of control on the power reception side. Specifically, for example, the power reception side control circuit includes a detection circuit. The detection circuit detects over-discharge, overvoltage, overcurrent, temperature abnormality, and the like.

The load 300 includes, for example, a battery 310 and a power supply target 320 of the battery 310. The battery 310 is, for example, a rechargeable secondary battery and is, for example, a lithium battery or a nickel battery. The power supply target 320 is a device that is provided in electronic equipment incorporating the power reception device 100 and is, for example, a power supply target of the battery 310.

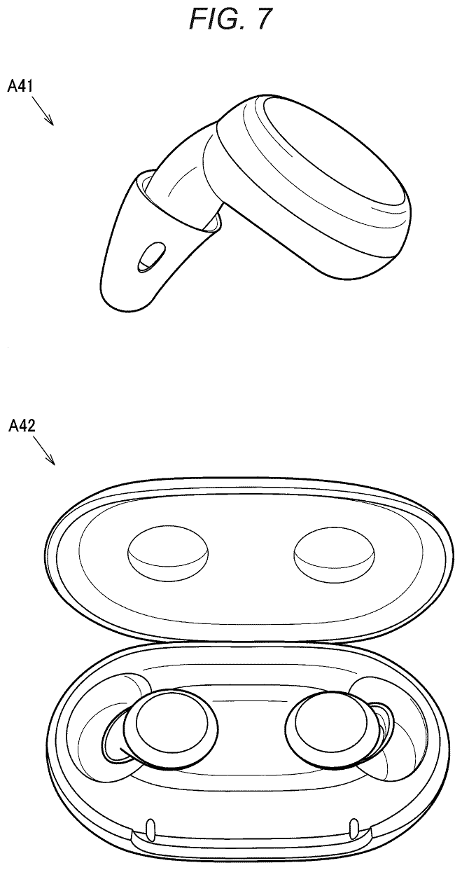

As explained above, the contactless power transmission system to which the switching regulator 1 in the present embodiment is applied can be used, for example, for charging electronic equipment. The electronic equipment is, for example, an earphone indicated by A41 in FIG. 7. The earphone indicated by A41 is more specifically a hearing aid earphone but may be another wireless earphone such as an earphone for audio viewing. The earphone indicated by A41 can be housed in a charging case indicated by A42. In this case, the earphone indicated by A41 in FIG. 7 corresponds to the power reception device 100 and the load 300 illustrated in FIG. 6 and the charging case indicated by A42 in FIG. 7 corresponds to the power transmission device 200 illustrated in FIG. 6. That is, electric power is supplied to the charging case indicated by A42 in FIG. 7 via a not-illustrated power supply adapter. This electric power can charge a battery incorporated in the earphone indicated by A41 with contactless power transmission and can cause the earphone to operate.

Electronic equipment to which the contactless power transmission system explained above can be applied is not limited to the electronic equipment illustrated in FIG. 7 and various types of equipment can be assumed. For example, various types of electronic equipment such as a wristwatch, a biometric information measurement device, a mobile information terminal, a cordless telephone, a shaver, an electric toothbrush, a wrist computer, a handy terminal, in-vehicle equipment, a hybrid vehicle, an electric vehicle, an electric motorcycle, and an electric bicycle can be assumed.

As explained above, the present embodiment relates to the circuit device used in a switching regulator that outputs an output voltage obtained by regulating a power supply voltage with an inductor and a switching element that drives the inductor. The circuit device includes an error amplifier, a slope voltage generation circuit, an addition circuit, a comparator, and a switching control circuit. The error amplifier amplifies the error between a comparison voltage corresponding to the output voltage and a reference voltage and outputs an error voltage. The slope voltage generation circuit generates a slope voltage. The addition circuit adds an addition voltage corresponding to the output voltage to the slope voltage and outputs a post-addition slope voltage. The comparator compares the error voltage and the post-addition slope voltage and outputs a pulse signal, which is a comparison result. The switching control circuit performs switching control on the switching element based on the pulse signal.

As explained above, since the circuit device in the present embodiment includes the addition circuit, when a load current increases, it is possible to extend a period in which the switching element is on. Accordingly, when the load current increases, a decrease in the output voltage can be reduced. Accordingly, the circuit device in the present embodiment can be applied to more types of electronic equipment.

The addition voltage may lower as the output voltage is lower.

This makes it possible to, when the output voltage decreases, reduce an initial voltage of the post-addition slope voltage. Accordingly, it is possible to construct a circuit device that, when the output voltage decreases, can extend the period in which the switching element is on.

The addition voltage may be a voltage obtained by dividing the output voltage or the output voltage itself.

This makes it possible to construct a circuit device corresponding to both of the case in which the output voltage is divided to be the addition voltage and the case in which the output voltage itself is the addition voltage.

The circuit device may include a first voltage divider circuit that divides the output voltage and outputs the comparison voltage to the error amplifier and a second voltage divider circuit that divides the output voltage and outputs the addition voltage to the addition circuit.

This makes it possible to input, to the addition circuit, the addition voltage generated based on the second voltage divider circuit on which fluctuation in the output voltage is directly reflected. Accordingly, it is possible to more quickly perform feedback of the output voltage with respect to the fluctuation.

A voltage division ratio of the first voltage divider circuit may be variable.

This makes it possible to make the output voltage variable. Therefore, the circuit device can be used for wider uses.

The slope voltage generation circuit may generate a slope voltage that rises from an initial voltage at a given slope, the addition circuit may add the addition voltage to the slope voltage and output the post-addition slope voltage, and the switching control circuit may change the switching element from ON to OFF based on the comparator determining that the post-addition slope voltage has exceeded the error voltage.

This makes it possible to, by linearly changing the post-addition slope voltage, construct a circuit that controls a period in which the switching element is on.

In a given period after the switching element is changed from ON to OFF, the switching control circuit may turn off the switching element and the slope voltage generation circuit may maintain the slope voltage at the initial voltage. After the given period has elapsed, the switching control circuit may change the switching element from OFF to ON and the slope voltage generation circuit may raise the slope voltage at a given slope.

This makes it possible to construct a circuit that, by linearly changing the post-addition slope voltage, controls both of the period in which the switching element is on and the period in which the switching element is off.

The present embodiment relates to a switching regulator including the circuit device explained above, the switching element, and the inductor.

Although the present embodiment is explained in detail as explained above, those skilled in the art could easily understand that many modifications can be made without substantially departing from the novel matters and the effects of the present disclosure. Therefore, all such modifications are deemed to be included in the scope of the present disclosure. For example, a term described at least once together with a different term having a broader meaning or the same meaning in the specification or the drawings can be replaced with the different term in any place in the specification or the drawings. All combinations of the present embodiment and the modifications are also included in the scope of the present disclosure. The configurations, operations, and the like of the circuit device, the switching regulator, and the like are not limited to those explained in the present embodiment, and various modifications can be made.

What is claimed is:

1. A circuit device used in a switching regulator that outputs an output voltage obtained by regulating a power supply voltage with an inductor and a switching element that drives the inductor, the circuit device comprising:
an error amplifier configured to amplify an error between a comparison voltage corresponding to the output voltage and a reference voltage and output an error voltage;
a slope voltage generation circuit configured to generate a slope voltage;
an addition circuit configured to add an addition voltage corresponding to the output voltage to the slope voltage and output a post-addition slope voltage;
a comparator configured to compare the error voltage and the post-addition slope voltage and output a pulse signal, which is a comparison result; and
a switching control circuit configured to perform switching control on the switching element based on the pulse signal.

2. The circuit device according to claim 1, wherein the addition voltage is lower as the output voltage is lower.

3. The circuit device according to claim 1, wherein the addition voltage is a voltage obtained by dividing the output voltage or the output voltage itself.

4. The circuit device according to claim 1, further comprising:
a first voltage divider circuit configured to divide the output voltage and outputs the comparison voltage to the error amplifier; and
a second voltage divider circuit configured to divide the output voltage and outputs the addition voltage to the addition circuit.

5. The circuit device according to claim 4, wherein a voltage division ratio of the first voltage divider circuit is variable.

6. The circuit device according to claim 1, wherein
the slope voltage generation circuit generates the slope voltage that rises from an initial voltage at a given slope,
the addition circuit adds the addition voltage to the slope voltage and outputs the post-addition slope voltage, and
the switching control circuit changes the switching element from ON to OFF based on the comparator determining that the post-addition slope voltage exceeded the error voltage.

7. The circuit device according to claim 6, wherein
in a given period after the switching element changes from ON to OFF, the switching control circuit turns off the switching element and the slope voltage generation circuit maintains the slope voltage at the initial voltage, and
after the given period elapsed, the switching control circuit changes the switching element from OFF to ON and the slope voltage generation circuit raises the slope voltage at the given slope.

8. A switching regulator comprising:
the circuit device according to claim 1;
the switching element; and
the inductor.
